(19) United States
(12) Patent Application Publication
(10) Pub. No.: US 2010/0332902 A1
(43) Pub. Date: Dec. 30, 2010

(54) Power efficient watchdog service

(76) Inventors: Rajesh Banginwar, Hillsboro, OR (US); Rajesh Kapoor, El Dorado Hills, CA (US); Bruce L. Fleming, Santa Clara, CA (US)

Correspondence Address: Caven & Aghevli LLC;c/o CPA Global, P.O. BOX 52050, MINNEAPOLIS, MN, 55402, US

(21) Appl. No.: 12/459,295

(22) Filed: Jun. 30, 2009

(51) Int. Cl. G06F 11/14; G06F 1/26; G06F 11/30; G06F 11/07

(52) U.S. Cl. 714/23; 713/300; 714/47; 714/2; 714/E11.023; 714/E11.113; 714/E11.179

(57) ABSTRACT

An electronic device comprises a first processor, a computer readable memory medium and logic instructions stored in the computer readable medium which, when executed by the first processor, configure the first processor to implement a watchdog module which monitors an operating status of one or more critical processes executing on the first processor and implements a recovery process when the one or more of the critical processes executing on the first processor fails. The device further comprises a system controller unit coupled to the first processor by a communication bus, wherein system controller unit activates the watchdog module periodically and only when the first processor is in at least one predetermined power state. Other embodiments may be described.

### RELATED APPLICATIONS

None.

### BACKGROUND

Some electronic devices such as computing systems may utilize a device referred to as a watchdog service or a watchdog module. Such watchdog devices may be configured to monitor critical application processes which execute on one or more processors on the electronic device, and to invoke corrective actions if a critical application process fails or otherwise becomes unavailable. Further, such watchdog devices may consume significant power, which may raise issues in portable electronic devices which rely on battery power.

### BRIEF DESCRIPTION OF THE DRAWINGS

The detailed description is described with reference to the accompanying figures.

FIG. 1 is a schematic illustration of an exemplary electronic device which may be adapted to implement a power efficient watchdog service in accordance with some embodiments.

FIG. 2 is a schematic illustration of components of an exemplary electronic device adapted to implement a power efficient watchdog service in accordance with some embodiments.

FIG. 3 is a flowchart illustrating operations in a method to implement a power efficient watchdog service in an electronic device, in accordance with some embodiments.

FIG. 4 is a diagram illustrating interactions between various elements of a system to implement a power efficient watchdog service in an electronic device, in accordance with some embodiments.

### DETAILED DESCRIPTION

Described herein are exemplary systems and methods to implement a power efficient watchdog service in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

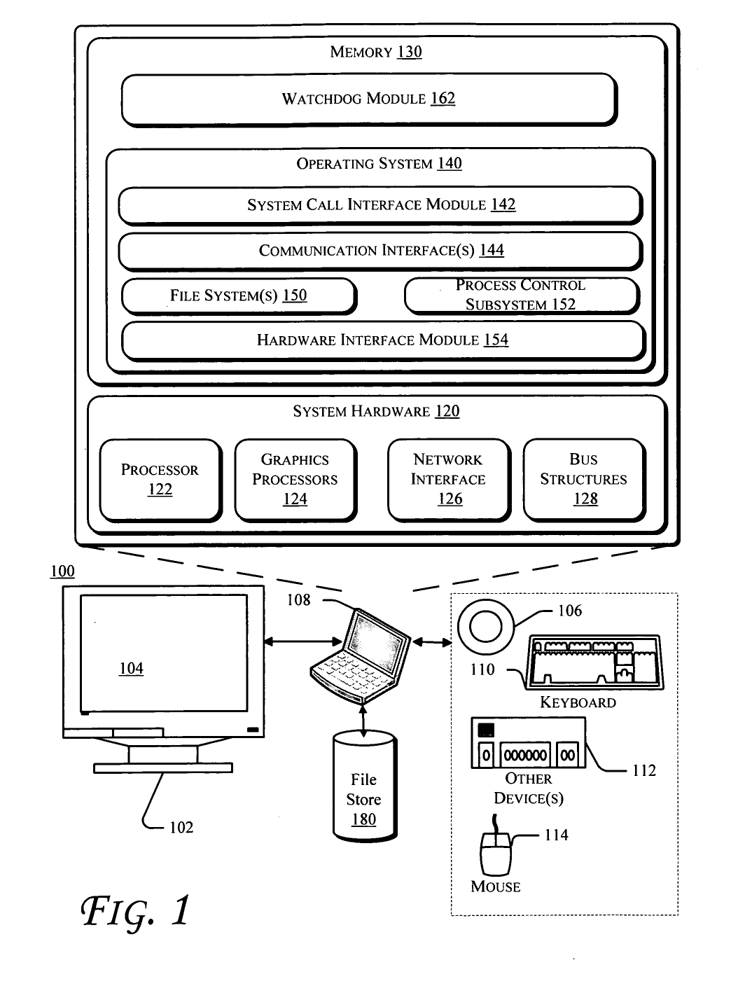

FIG. 1 is a schematic illustration of an exemplary electronic device which may be adapted to implement a power efficient watchdog service in accordance with some embodiments. In one embodiment, system 100 includes a computing device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

The computing device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, at least two graphics processors 124, network interfaces 126, and bus structures 128. In one embodiment, processor 122 may be embodied as an Intel® Atom processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processors 124 may function as adjunct processors that manages graphics and/or video operations. Graphics processors 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11 G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In various embodiments, the computing device 108 may be embodied as a personal computer, a laptop computer, a personal digital assistant, a mobile telephone, an entertainment device, or another computing device.

In one embodiment, memory 130 includes a watchdog module 162 in computing system 100. In one embodiment, watchdog module 162 may include logic instructions encoded in a computer-readable medium which, when executed by processor 122, cause the processor 122 to implement operations to ensure that critical application processes on the platform are running. If one or more errors occur in a critical process, the operating system 140 can take corrective action, which may include restarting the critical process or rebooting the computing system 100.

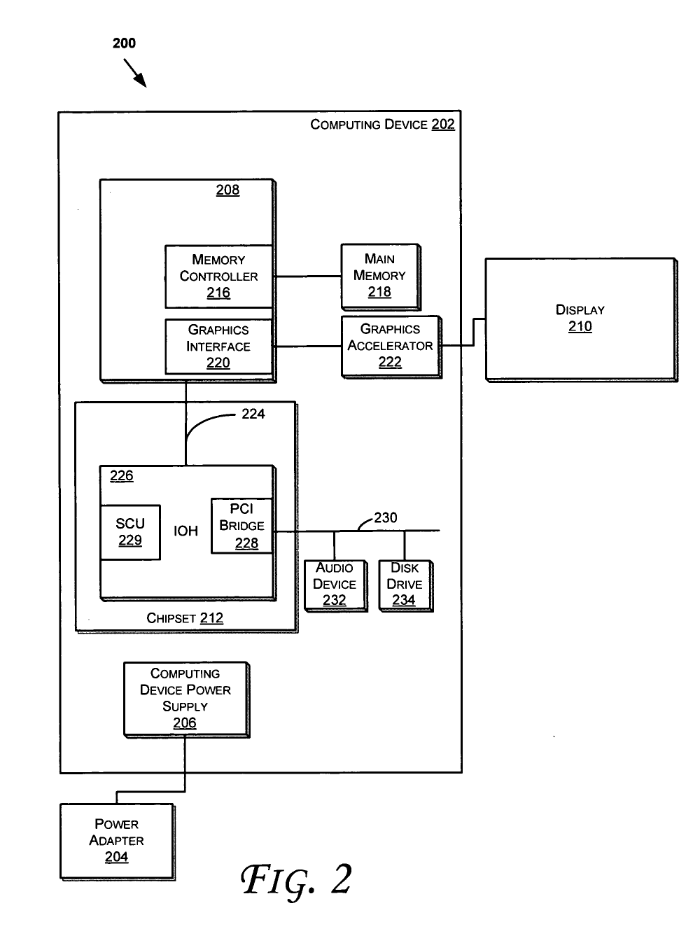

FIG. 2 is a schematic illustration of components of an exemplary electronic device 200 adapted to implement a power efficient watchdog service in accordance with some embodiments. In the embodiment depicted in FIG. 2, the electronic device 200 includes a computing device 202 and a power adapter 204 (e.g., to supply electrical power to the computing device 202). The computing device 202 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 202 (e.g., through a computing device power supply 206) from one or more of the following sources: one or more battery packs, an alternating current (AC) outlet (e.g., through a transformer and/or adaptor such as a power adapter 204), automotive power supplies, airplane power supplies, and the like. In some embodiments, the power adapter 204 may transform the power supply source output (e.g., the AC outlet voltage of about 110 VAC to 240 VAC) to a direct current (DC) voltage ranging between about 7 VDC to 12.6 VDC. Accordingly, the power adapter 204 may be an AC/DC adapter.

The computing device 202 may also include one or more central processing unit(s) (CPUs) 208. In some embodiments, the CPU 408 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

The CPU 208 may include a memory controller 216 that is coupled to a main system memory 218. The main system memory 218 stores data and sequences of instructions that are executed by the CPU 208, or any other device included in the system 200. In some embodiments, the main system memory 218 includes random access memory (RAM); however, the main system memory 218 may be implemented using other memory types such as dynamic RAM (DRAM), synchronous DRAM (SDRAM), and the like.

The CPU 208 may also include a graphics interface 220 coupled to a graphics accelerator 222. In some embodiments, the graphics interface 220 is coupled to the graphics accelerator 222 via an accelerated graphics port (AGP). In some embodiments, a display (such as a flat panel display) 240 may be coupled to the graphics interface 220 through, for example, a signal converter that translates a digital representation of an image stored in a storage device such as video memory or system memory into display signals that are interpreted and displayed by the display. The display 240 signals produced by the display device may pass through various control devices before being interpreted by and subsequently displayed on the display.

An interface 224 couples the MCH 214 to an input/output hub (IOH) 226. The ICH 226 provides an interface to input/output (I/O) devices coupled to the electronic device 200. The ICH 226 may be coupled to a peripheral component interconnect (PCI) bus. Hence, the ICH 226 includes a PCI bridge 228 that provides an interface to a PCI bus 230. The PCI bridge 228 provides a data path between the CPU 208 and peripheral devices. Additionally, other types of I/O interconnect topologies may be utilized such as the PCI Express™ architecture, available through Intel® Corporation of Santa Clara, Calif.

The PCI bus 230 may be coupled to an audio device 232 and one or more disk drive(s) 234. Other devices may be coupled to the PCI bus 230. In alternate embodiments, the CPU 208 and the MCH 214 may be combined to form a single chip. Furthermore, the graphics accelerator 222 may be included within the MCH 214 in other embodiments.

Additionally, other peripherals coupled to the ICH 226 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 202 may include volatile and/or nonvolatile memory.

In some embodiments a system controller unit (SCU) 229 may be integrated into, or coupled with, the ICH 226. The SCU 229 may be embodied as a low-power controller which is responsible for power management functions on the computing device 202, including the watchdog functionality implemented by the watchdog module 162 depicted in FIG. 1, which executes on the CPU 208.

In some embodiments, the SCU 229 cooperates with the CPU 208 to reduce the amount of power consumed by the watchdog functionality of the implemented by the watchdog module 162. In operation, the SCU 229 maintains one or more timers, and activates the watchdog module 162 when the timers reach a specific threshold. Further, in some embodiments the timers tick in an anachronistic fashion, and only when the CPU 208 is in predetermined power states. For example, the timer(s) maintained by the SCU 229 may tick only when the CPU 208 is in one or more active power states. By contrast when the CPU 208 is in one or more sleeping, or low-power states, the timer(s) maintained by the SCU 229 are halted. Thus, by using the low-power SCU 229 to monitor the power state of the CPU 208 and to deactivate the timers when the CPU 208 is in an inactive power state, the watchdog module 162 is activated only after a threshold amount of active CPU time has elapsed.

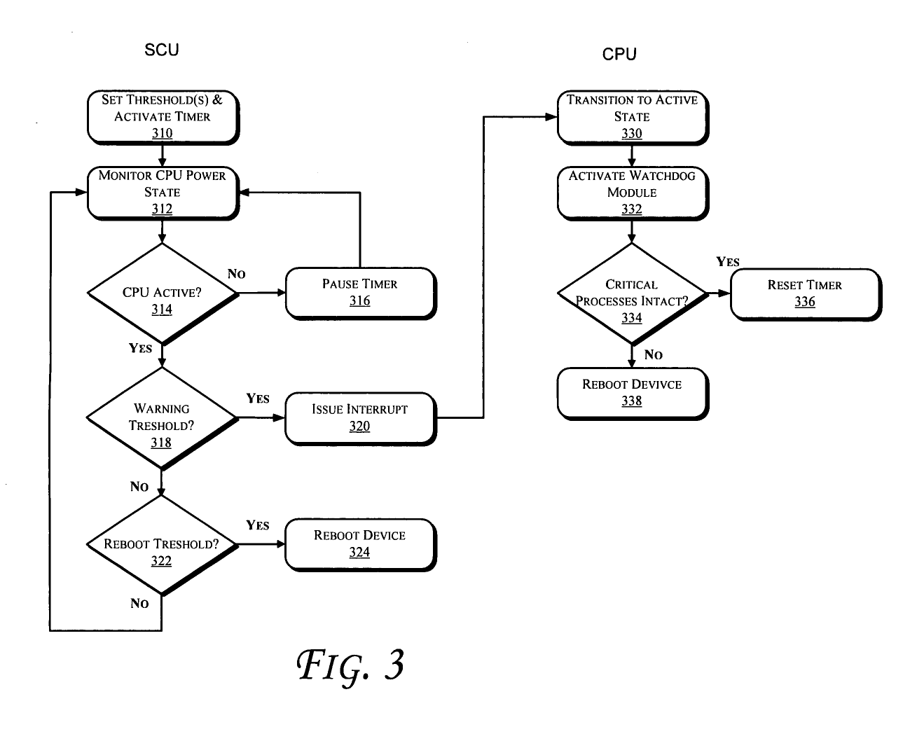

FIG. 3 is a flowchart illustrating operations in a method to implement a power efficient watchdog service in an electronic device, in accordance with some embodiments. Referring to FIG. 3, the flowchart illustrates aspects of the cooperation between the SCU 229 and the CPU 208 to reduce power consumption by the watchdog service. At operation 310 the SCU 229 sets one or more thresholds and activates a timer. In some embodiments, the SCU sets a reboot threshold and a warning threshold. The reboot threshold represents a time threshold which, when elapsed, invokes a reboot of the device. The warning threshold represents a time threshold which, when elapsed, triggers the SCU to generate a warning, e.g., in the form of an interrupt, that the device is about to be rebooted.

At operation 312 the SCU monitors the power state of the CPU 208. In one embodiment, the CPU may operate in one of seven power states, referred to as C-states in the Advanced Configuration and Power Interface (ACPI) specification. The seven C-states are designated by C0 (Active), C1 (Halt), C2 (Stop Grant), C3 (Deep Sleep), C4 (Deeper Sleep), C5, and C6. Thus, in general higher C-states indicate deeper sleep modes for the processor. In some embodiments, the CPU 208 transmits a message to the SCU 229 via the communication bus 224 when the CPU 208 changes C-states.

At operation 314 it is determined whether the CPU 208 is in an active state. In one embodiment, the phrase “active state” refers to a state in which one or more critical processes are necessary for continued operations of the processor. For example, an active state may refer to states C0, C1, and C2. By contrast, processor states C3, C4, C5, and C6 may be considered inactive power states. If, at operation 314, the CPU is not in an active state, then control passes to operation 316 and the timer is paused. Control then passes back to operation 312 and the SCU 229 continues to monitor the CPU power state. Thus, as long as the CPU remains in an inactive power state the SCU 229 will stop the timer from ticking and will continue monitoring the power state of the CPU 208.

By contrast, if at operation 314 the CPU is in an active power state, then control passes to operation 318. At operation 318 it is determined whether the timer has crossed a warning threshold. In some embodiments the SCU generates an interrupt in a time frame between approximately 100 milliseconds and 100 milliseconds before the timer crosses a reboot threshold. If, at operation 318, the timer has crossed a warning threshold, then control passes to operation 320 and the SCU 229 issues an interrupt, which is transmitted to the CPU 208.

The CPU 208 receives the interrupt and, at operation 330, the CPU transitions to an active state. At operation 332 the watchdog module 332 is activated, e.g., by invoking a watchdog driver. As described above, the watchdog module monitors critical processes executing on the processor 208 to determine whether the critical process are intact. If, at operation 334 the critical processes executing on processor 208 are intact, then control passes to operation 336 and the timer is reset. Control can then pass back to operation 310 and the operations of FIG. 3 are repeated. By contrast, if at operation 334 one or more critical processes are not intact, then control passes to operation 338 and the device is rebooted. In some embodiments, a warning message may be presented prior to rebooting the device.

The watchdog driver, which provides access to the watchdog module 162, will be non-reopenable. When the watchdog module 162 is closed, which indicates that something has gone wrong with the process responsible for managing the watchdog, the system is rebooted.

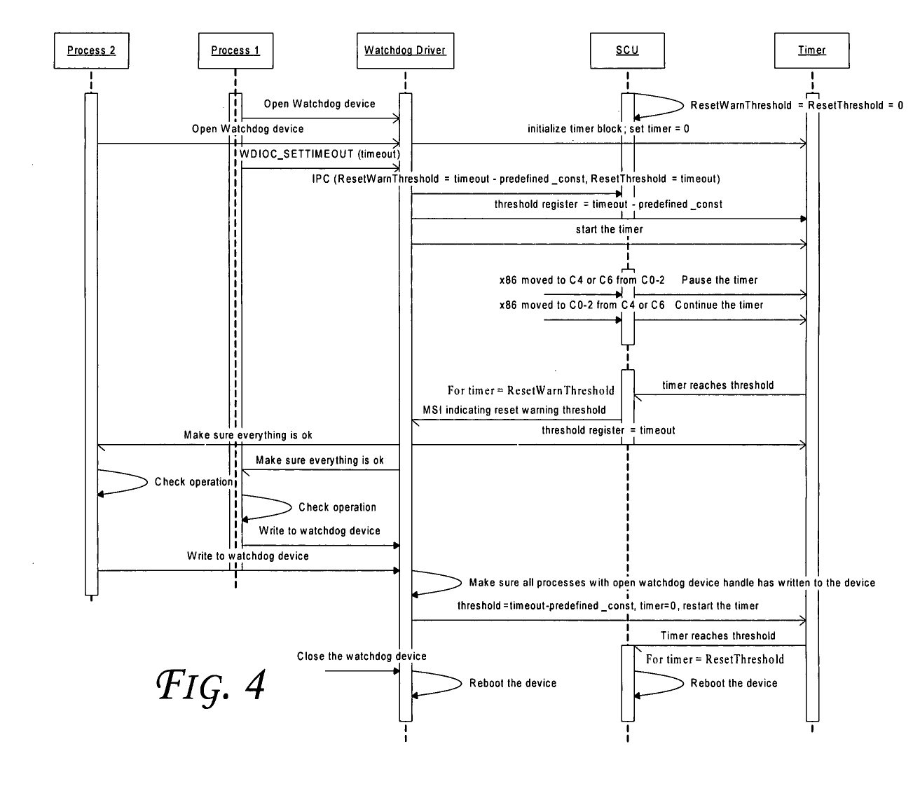

FIG. 4 is a diagram illustrating interactions between various elements of a system to implement a power efficient watchdog service in an electronic device, in accordance with some embodiments. Referring to FIG. 4, the watchdog driver may allow multiple processes to open the watchdog service provided by watchdog module 162. In some embodiments, all processes which are expected to be running all the time once started will open the watchdog device. FIG. 4 depicts an arrangement in which two processes, process 1 and process 2, open the watchdog device. This is illustrated in the diagram by arrows from process 1 and process 2 to the watchdog driver.

Only the first requesting process, (i.e., process 1) can set the timeout value. This request is represented in FIG. 4 by arrow labeled WDIOC_SETTIMEOUT from process 1 to the watchdog driver. The driver will ignore WDIOC_SETTIMEOUT commands from any other process. Thus, the watchdog service provided by the watchdog module 162 will be owned by root user and a new group called watchdog. The process using the watchdog will need to belong to this watchdog group to use the service. This way, only trusted and approved processes will be able to use the watchdog service.

In response to a request to open the watchdog device, the watchdog driver initializes the timer, sets the timer registers, and starts the timer. As described above, the SCU 229 monitors the C-state of the processor. If the processor (X86) moves from a C4 or a C6 state to a C0, C1, or C2 state, then the timer is paused. By contrast, if the processor (X86) moves from a C0, C1, or C2 state to a C4 or C6 state, then the timer is resumed.

If the timer reaches the warning threshold, then the SCU transmits a request to the watchdog driver which indicates a reset warning. In response to the request, the watchdog driver invoices the watchdog module 162 to check that process 1 and process 2 are executing correctly. Process 1 and process 2 write responses to the watchdog driver. If the responses indicate that the processes are executing correctly, then the watchdog driver resets the timer. By contrast, if the processes fail to respond with an indication that all processes are executing correctly, then the timer reaches its threshold and the SCU reboots the device.

Thus, by providing the SCU 229 in a low-power controller separate from the CPU 208, and by further configuring the SCU 229 to implement timers that tick only when the CPU 208 is in an active power state, the power required to operate the watchdog service is reduced.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An electronic device, comprising:
a first processor;
a computer readable memory medium; and
logic instructions stored in the computer readable medium which, when executed by the first processor, configure the first processor to implement a watchdog module which:
monitors an operating status of one or more critical processes executing on the first processor; and
implements a recovery process when the one or more of the critical processes executing on the first processor fails; and
a system controller unit coupled to the first processor by a communication bus, wherein system controller unit activates the watchdog module periodically and only when the first processor is in at least one predetermined power state.

2. The electronic device of claim 1, wherein:
the first processor comprises a central processing unit (CPU); and
the system controller unit is implemented as a low-power controller on a second processor, separate from the first processor.

3. The electronic device of claim 2, wherein the system controller unit:
maintains a watchdog activation timer; and
activates the watchdog activation timer only when the first processor is in at least one predetermined power state.

4. The electronic device of claim 3, wherein the system controller unit reboots the electronic device when the watchdog activation timer passes a threshold.

5. The electronic device of claim 4, wherein:
the system controller unit generates an interrupt prior to the watchdog activation timer reaching the threshold.

6. The electronic device of claim 5, wherein, in response to the interrupt:
the first processor is activated; and
a watchdog service executing on the first processor checks to determine whether one or more critical processes are executing on the first processor.

7. The electronic device of claim 6, wherein, in response to a determination that one or more critical processes executing on the first processor have failed, the watchdog service reboots the electronic device.

8. The electronic device of claim 6, wherein, in response to a determination that one or more critical processes executing on the first processor are executing successfully, the watchdog service resets a threshold timer for the watchdog module.

9. The electronic device of claim 6, wherein, in response to a determination that one or more critical processes executing on the first processor have failed, the watchdog service resets a threshold timer for the watchdog module.

10. The electronic device of claim 3, wherein the watchdog activation timer is paused when the electronic device transitions from an active state to a low-power sleep state.

11. The electronic device of claim 3, wherein the watchdog activation timer is started when the electronic device transitions from a low-power sleep state to an active state.

12. A method to implement a power efficient watchdog service in an electronic device, comprising:
on a first processor:
monitoring an operating status of one or more critical processes executing on a first processor; and
implementing a recovery process when the one or more of the critical processes executing on the first processor fails; and
activating, on a system controller unit coupled to the first processor by a communication bus a watchdog module periodically and only when the first processor is in at least one predetermined power state.

13. The method of claim 12, wherein:
the first processor comprises a central processing unit (CPU); and
the system controller unit is implemented as a low-power controller on a second processor, separate from the first processor.

14. The method of claim 13, wherein the system controller unit:
maintains a watchdog activation timer; and
activates the watchdog activation timer only when the first processor is in at least one predetermined power state.

15. The method of claim 14, wherein the system controller unit reboots the electronic device when the watchdog activation timer passes a threshold.

16. The method of claim 15, wherein:
the system controller unit generates an interrupt prior to the watchdog activation timer reaching the threshold.

17. The method of claim 16, wherein, in response to the interrupt:
the first processor is activated; and
a watchdog service executing on the first processor checks to determine whether one or more critical processes are executing on the first processor.

18. The method of claim 17, wherein, in response to a determination that one or more critical processes executing on the first processor have failed, the watchdog service reboots the electronic device.

19. The method of claim 17, wherein, in response to a determination that one or more critical processes executing on the first processor are executing successfully, the watchdog service resets a threshold timer for the watchdog module.

20. The method of claim 17, wherein, in response to a determination that one or more critical processes executing on the first processor have failed, the watchdog service resets a threshold timer for the watchdog module.

21. The method of claim 14, wherein the watchdog activation timer is paused when the electronic device transitions from an active state to a low-power sleep state.

22. The method of claim 14, wherein the watchdog activation timer is started when the electronic device transitions from a low-power sleep state to an active state.
